(19) United States
(12) Patent Application Publication
(10) Pub. No.: US 2024/0258850 A1
(43) Pub. Date: Aug. 1, 2024

(54) SYNCHRONOUS MACHINE EXCITED BY PERMANENT MAGNETS

(71) Applicant: Rolls-Royce Deutschland Ltd & Co KG, Blankenfelde-Mahlow (DE)

(72) Inventors: Andreas REEH, Nürnberg (DE); Christian LOESCH, Erlangen (DE)

(21) Appl. No.: 18/564,393

(22) PCT Filed: May 18, 2022
(86) PCT No.: PCT/EP2022/063406

§ 371 Date: Nov. 27, 2023

(30) Foreign Application Priority Data
May 27, 2021 (DE) 10 2021 113 775.6

(51) Int. Cl. H02K 1/2783; H02K 21/16

(52) U.S. Cl. CPC H02K 1/2783; H02K 21/16

(57) ABSTRACT

The invention relates to a synchronous machine which is excited by permanent magnets and has a stator (2) and a rotor (1) which rotates adjacent to the stator (2) about a longitudinal axis (3). The rotor (1) comprises a number of surface magnets which are disposed along the circumference of the rotor (1). The surface magnets are designed as Halbach arrays (4), each of which comprises tangential segments (PM1, PM4, PM5, PM8), in which the magnetisation direction (M) is oriented predominantly in the circumferential direction, and normal segments (PM2, PM3, PM6, PM7), in which the magnetisation direction (M) is oriented predominantly in the radial direction or counter to the radial direction, and in the field of the stator (2) the tangential segments (PM1, PM14, PM5, PM8) are subjected to a radially inwardly directed force (−Fn) and the normal segments (PM2, PM3, PM6, PM7) are subjected to a radially outwardly directed force (+Fn). According to the invention, the tangential segments (PM1, PM4, PM5, PM8) and the normal segments (PM2, PM3, PM6, PM7) are shaped in such a way that, by form fitting, the tangential segments (PM1, PM4, PM5, PM8) partially compensate for the forces directed radially outwards onto the normal segments (PM2, PM3, PM6, PM7) by means of the forces directed radially inwards onto the tangential segments (PM1, PM4, PM5, PM8).

This application is the National Stage of International Application No. PCT/EP2022/063406, filed May 18, 2022, which claims the benefit of German Patent Application No. DE 10 2021 113 775.6, filed May 27, 2021. The entire contents of these documents are hereby incorporated herein by reference.

### BACKGROUND

The present embodiments relate to a synchronous machine excited by permanent magnets.

Synchronous machines excited by permanent magnets (PMSM) allow high power and torque densities and are used in electrical drives for aircraft, for example. For a particularly high gravimetric torque density and also because of numerous other advantages, surface magnets with a high saturation polarization (e.g., Nd—Fe—B magnets) in Mallison-Halbach arrays may be used in the rotor of such machines. This spatial configuration of permanent magnets of different magnetization direction (e.g., polarization), which is often referred to simply as a Halbach array, concentrates the flux on one side of the array and largely cancels the field on the other side. One property of this configuration is the fact that the array allows higher flux densities than the individual components of the array because of the resulting superposition of the field lines.

One disadvantage of a magnet arrangement with a Halbach array is that the rotating orientation of the magnetization vectors makes it more difficult to mount the magnet bars in the circumferential direction owing to the effective forces of attraction and repulsion. An alternative way of magnetizing the pre-oriented magnet bars after rotor installation (e.g., charging with a very high field strength between the poles) requires expensive special tools and involves the risk of altering the magnetization at the adjacent poles.

In general, when using surface magnets in radial flux machines, there is the challenge of fixing the position of the surface magnets in the radial direction (e.g., normal) and circumferential direction (e.g., tangential direction) with respect to the axis of rotation against centrifugal forces that arise and against the forces that result from Maxwell stresses. At the same time, the torque resulting from the tangential forces is to be transmitted without slippage of the magnets under all operating conditions. These requirements result in high demands on a magnet positioning and retention device that positions and holds the surface magnets on the surface of the rotor. Such devices are configured as bandages, for example.

In this case, the aim with a synchronous machine excited by permanent magnets is generally to minimize the ratio of the air gap height to the magnet height in the air gap between the rotor and the stator. Making minimization of this gap more difficult are the aforementioned magnet positioning and retention devices that position the magnets in the air gap and entail a space requirement. For example, bandages disadvantageously take up installation space in the gap between the rotor and the stator.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, fastening of surface magnets on a rotor in synchronous machines that are excited by permanent magnets and have Halbach arrays is improved.

The present embodiments relate to a synchronous machine that is excited by permanent magnets and has a stator and a rotor that rotates adjacent to the stator about a longitudinal axis. In this case, the rotor has a plurality of surface magnets that are arranged along a circumference of the rotor. The surface magnets are configured as Halbach arrays, each of which has tangential segments, in which a magnetization direction is oriented predominantly in the circumferential direction, and normal segments, in which the magnetization direction is oriented predominantly in the radial direction or counter to the radial direction. In the field of the stator, the tangential segments are subjected to a radially inwardly directed force, and the normal segments are subjected to a radially outwardly directed force.

In one embodiment, the tangential segments and the normal segments are shaped such that, by form fitting, the tangential segments partially compensate for the forces directed radially outward onto the normal segments by the forces directed radially inward onto the tangential segments.

The present embodiments are based on the concept of exploiting the radially inwardly directed forces acting on the tangential segments in order, by form fitting, to counteract the radially outwardly directed forces of the normal segments. Thus, by virtue of the form fit, there is radially inwardly directed force transmission from the tangential segments to the normal segments, partially compensating the resulting forces on the normal segments, while the flux-concentrating effect of the Halbach arrangement is maintained. The total forces acting on the surface magnets are thereby homogenized, and therefore, the total retention force required and hence the demands on the required magnet positioning and retention devices, such as bandages, may be reduced.

This makes it possible to reduce the distance between the stator and the rotor (e.g., the air gap height), leading to a higher torque for the same magnet height. If the torque is to be kept constant, the magnet height may be reduced, and it is thereby possible to save mass and material costs since electrical machines with a high torque density typically use heavy and expensive rare earth magnets (e.g., neodymium-iron-boron or samarium-cobalt).

Another advantage associated with the present embodiments is that the present embodiments also simplify the mounting of the magnet bars of a Halbach array on the rotor, a nontrivial task on account of the high magnetic forces, since movement of the already mounted bars is prevented by the form fit and, as a result, it is possible to simplify complex mounting devices and processes. The outlay on manufacture may thus be reduced.

One embodiment provides that the tangential segments and the normal segments each have two lateral flanks in a cross-sectional view perpendicular to the longitudinal axis of the rotor, where a form fit between a respective tangential segment and a normal segment is provided by the fact that those flanks of the tangential segment and of the normal segment that adjoin one another in the circumferential direction adjoin one another with a form fit such that a relative movement in the radial direction is blocked. The form fit is thus provided by the mutually adjoining flanks of the tangential segment and the normal segment.

In this case, provision is made, for example, for those flanks of the tangential segment and of the normal segment that adjoin one another in the circumferential direction to have an orientation that deviates from a strictly radial orientation. In the case of an orientation of the flanks that deviates from a strictly radial orientation, the force acting radially inward on the tangential segments may be exploited in order to reduce the effective force on the normal segments.

For this purpose, provision is made, for example, for those flanks of the tangential segment and of the normal segment that adjoin one another in the circumferential direction to run in a planar manner, parallel and, at the same time, obliquely to the radial direction. The width of the tangential segment increases in the radial direction, and the width of the normal segment decreases in the radial direction. The oblique orientation of the flanks automatically provides a form fit. In one embodiment, a design of the flanks that is planar overall is associated with the advantage of easy production of the outer contour of the tangential segments and of the normal segments.

For this purpose, one embodiment provides that the flanks run obliquely to the radial direction, such that the angle between the flanks and the radial direction is in a range between 1° and 10°. The angle, therefore, does not have to be large in order to provide a form fit.

However, it is not necessary for the form fit between the tangential segment and the normal segment that those flanks of two tangential segments that adjoin one another in the circumferential direction and those flanks of two normal segments that adjoin one another in the circumferential direction form a form fit since these do not impose any forces on one another. These flanks may therefore extend in the radial direction but, as an alternative, it is likewise possible for the flanks to run obliquely to the radial direction (e.g., when, for reasons associated with manufacture, it is easier to bevel both flanks of a segment). In this context, embodiments provide that at least two normal segments adjoin one another within a Halbach array.

It is also possible in principle for a form fit between a tangential segment and a normal segment that adjoin one another in the circumferential direction to be provided in some other way. Another embodiment provides that those flanks of the tangential segment and of the normal segment that adjoin one another in the circumferential direction form projections and indentations that provide a form fit and prevent relative movement between the tangential segment and the normal segment in the radial direction.

The solution according to the present embodiments applies in principle to any Halbach arrays with any number of segments as long as at least three segments are present. One embodiment provides that the Halbach arrays have two tangential segments and two normal segments per magnetic pole, wherein provision may be made for the two normal segments to be arranged directly adjoining one another in the circumferential direction and to be bounded on both sides by the two tangential segments. In this case, provision may further be made for two magnetic poles formed by Halbach arrays to be arranged directly adjoining one another in the circumferential direction as a magnetic pole pair.

One embodiment provides that the direction of magnetization changes by a fixed angle of, for example, 60°, between two adjacent segments of the Halbach array.

One further embodiment provides that the surface magnets that are arranged along the circumference of the rotor are fixed on the rotor without an adhesive layer. This is made possible by the fact that movement of the surface magnets is prevented by the form fit provided according to the present embodiments between the tangential segments and the normal segments. It is then sufficient, for example, for a bandage on the outer circumference of the rotor to fix the surface magnets. The elimination of an adhesive layer is associated with the advantage of improved heat conduction from the surface magnets to the rotor since an adhesive layer typically has a considerable thermal resistance.

Another embodiment provides that the stator of the electrical machine includes segmented stator coils that are configured as individual tooth coils. It is thereby possible to provide particularly high magnetic field strengths. In principle, however, the stator may be implemented with stator coils in any desired manner and using any desired winding technique.

In one embodiment, the synchronous machine is configured as a synchronous machine excited by permanent magnets. In this case, the stator is equipped with coils, while external surface magnets are attached to the rotor. The AC voltage is applied to the stator coils.

The synchronous machine according to the present embodiments may be implemented in the context of a large number of design principles (e.g., as a radial flux machine (with an orientation of the normal vector of the average air gap area in the radial direction), an axial flux machine (with an orientation of the normal vector of the average air gap area in the axial direction), or a transverse flux machine (with an axial or radial air gap orientation)). Further, it is possible to use designs in which the rotor is configured as an internal rotor, and designs in which the rotor is configured as an external rotor.

### BRIEF DESCRIPTION OF THE DRAWINGS

The invention will be explained in greater detail below using a plurality of embodiments and with reference to the figures of the drawing, in which:

FIG. 1 shows an example of a Halbach array that includes tangential segments and normal segments;

FIG. 2 shows magnetic normal forces acting on segments of the Halbach array in FIG. 1 against a rotor position in normal operation and after a three-phase short circuit in an electrical machine with a distributed winding;

FIG. 3 shows an embodiment of a Halbach array that includes tangential segments and normal segments, where a tangential segment and a normal segment each adjoin one another with a form fit and the form fit is provided by an orientation of the flanks;

FIG. 4 shows the Halbach array in FIG. 3, additionally showing the normal forces acting on the individual segments;

FIG. 5 shows a detail of an electric motor having a rotor and a stator, where the rotor has surface magnets in the form of a Halbach array in accordance with FIGS. 3 and 4;

FIG. 6 shows the magnetic normal forces acting on the segments of the Halbach array in FIG. 5 against the rotor position in the case of an electrical machine with a concentrated toothed coil winding;

FIG. 7 shows another embodiment of a Halbach array that includes tangential segments and normal segments, where a tangential segment and a normal segment each adjoin one another with a form fit and the form fit is formed by projections and indentations in adjacent flanks; and

FIG. 8 shows a cross-sectional view of an electric motor that includes a rotor having surface magnets, in accordance with the prior art.

### DETAILED DESCRIPTION

For a better understanding of the present embodiments and of the differences between the present embodiments and the prior art, a prior-art synchronous machine that is excited by permanent magnets and is in the form of an electric motor is first explained with reference to FIG. 8.

The electric motor includes a rotor 1 and a stator 2. The stator 2 has a number of winding cores 20, onto which coils (not illustrated) are wound. The rotor 1 is arranged on the inside of the stator 2 and rotates about a longitudinal axis 3 that defines an axial direction. A radial direction r is perpendicular to the axial direction.

The rotor 2 has a number of permanent magnets that are arranged as surface magnets 11, 12 on an outside of the rotor 2. In this arrangement, two surface magnets 11, 12 that are adjacent in a circumferential direction each have different polarity and together form a magnetic circuit with a magnetic flux density B.

Between the stator 1 and the rotor 2, an air gap 8, which is not shown to scale, is formed. The surface magnets 11, 12 have a radial height hm. The surface magnets 11, 12 are fixed on the outer circumference of the rotor 1 by a magnet positioning and retention device (not illustrated). Such a device includes, for example, a bandage that is formed by a glass, metal, or carbon fiber sleeve. Such a bandage reduces the size of the air gap 8.

In the case of an electric motor in accordance with FIG. 8, the torque increases as a first approximation linearly with the amplitude of the fundamental flux density wave in the air gap. This, in turn, is hyperbolically dependent on the ratio of the air gap height & to the magnet height hm. In order to achieve a torque density of the machine that is as high as possible, this ratio is to be minimized. While an increase in the magnet height is limited as regards an increase in the torque density on account of the relatively heavy permanent magnet material, the air gap height may be reduced within the scope of the mechanical limitations in order to provide a minimum distance between the stator and the rotor under all operating conditions. Reducing the air gap height (e.g., of the order of several tenths of a millimeter to a few millimeters, depending on the application) is made more difficult not only by possible deformations of the bearings, the shaft, the rotor, and the stator, but also by any necessary space requirement for the magnet positioning and retention device.

The aim is to reduce such a space requirement since such a reduction and a corresponding adaptation of the air gap height lead directly to an increase in torque. As an alternative, the magnet height and thus the mass may be reduced for a constant torque density.

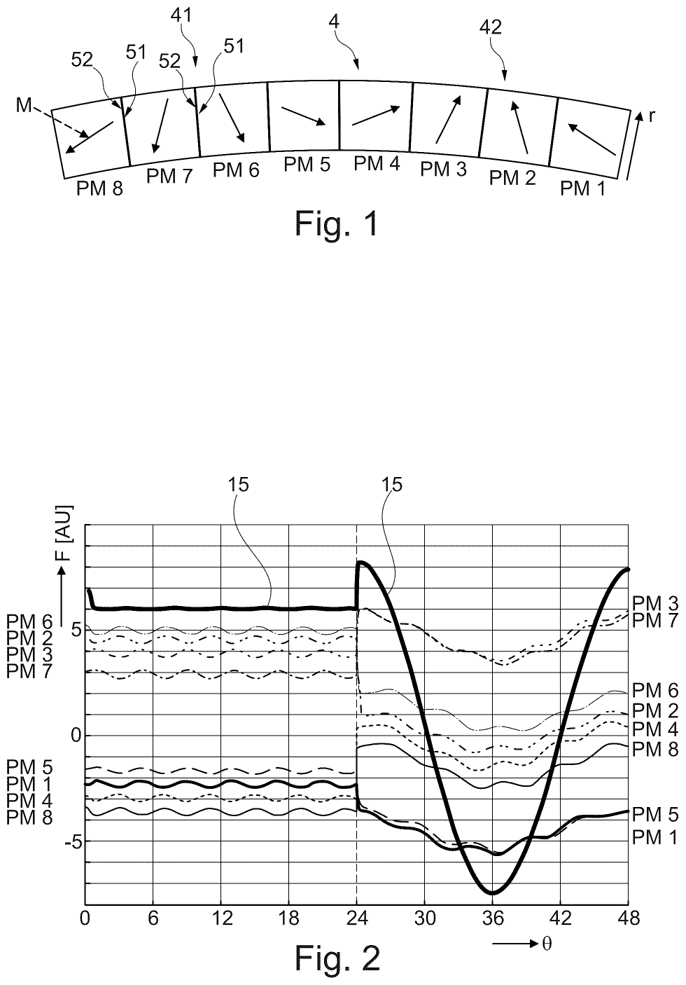

According to the present embodiment, the space requirement for a magnet positioning and retention device may be reduced by reducing the forces that such a magnet positioning and retention device is to be able to retain. In this regard, FIGS. 1 to 4 illustrate a first embodiment.

FIG. 1 shows a Halbach array 4 that includes eight segments PM 1 to PM 8 adjoining one another in the circumferential direction. In this arrangement, four segments PM 1 to PM 4 and PM 5 to PM 8 form magnetic poles 41, 42, respectively, and the eight segments PM 1 to PM 8 together form a pole pair. A plurality of such Halbach arrays 4 is arranged in the circumferential direction of a rotor. For example, at least two pole pairs are provided over the full circle of 360°, where the number of pole pairs may also be significantly higher (e.g., 30).

The segments PM 1 to PM 8 each have a magnetization M that differs from segment to segment in accordance with the design as a Halbach array 4. The magnetization direction M of the individual segments rotates by 60° from segment to segment in the example illustrated. Provision is made, for example, for some of the segments (e.g., segments PM 1, PM 4, PM 5, PM 8) to have a magnetization M that is oriented predominantly in the circumferential direction. These segments are referred to as tangential segments. The other segments PM 2, PM 3, PM 6, PM 7 have a magnetization M that is oriented predominantly in the radial direction (e.g., in the radial direction or counter to the radial direction). These segments are referred to as normal segments.

Each of the segments PM 1 to PM 8 has two lateral flanks 51, 52, where, in the illustration in FIG. 1, the respective right flank is denoted by the reference sign 51 and the respective left flank is denoted by the reference sign 52. Since the mutually adjoining flanks 51, 52 of two adjacent segments are planar, in parallel, and rest against one another, the mutually adjoining flanks 51, 52 are represented in the illustration in FIG. 1 by just one line. In this case, the situation is such that the lateral flanks 51, 52 each run in the radial direction.

FIG. 2 shows the magnetic normal forces acting on the individual segments PM 1 to PM 8 in the field of a stator (e.g., corresponding to the stator 2 in FIG. 8). In this case, the magnetic normal forces on the individual segments PM 1 to PM 8 are shown against the rotor position θ in the case of an electrical machine with a distributed winding (q=1). In this context, magnetic normal forces denote the forces that are directed either radially inward or radially outward. As shown, normal forces acting on the tangential segments PM1, PM 4, PM 5, PM 8 are negative (e.g., are directed radially inward). In contrast, the normal forces acting on the normal segments PM 2, PM 3, PM 6, PM 7 are positive (e.g., are directed radially outward). The curve 15 indicates the sum of these forces, which is positive.

A three-phase short circuit was simulated from a rotor position of 24°. In a certain way, this represents an additional operating case that is to be taken into account in the design of a magnet positioning and retention device. The normal forces and hence also the sum curve 15 decrease significantly in the case of a short circuit. It is significant that, even in the case of a short circuit, the normal forces on the normal segments PM 2, PM 3, PM 6, PM 7 are positive, and those on the tangential segments PM1, PM 4, PM 5, PM 8 are negative; therefore, there is no qualitative change as regards the ratio of the individual normal forces. Further, the sum of the normal forces according to curve 15 does not increase or does not increase substantially, and therefore, to this extent, the demands on a magnet positioning and retention device are not increased in the event of a short circuit.

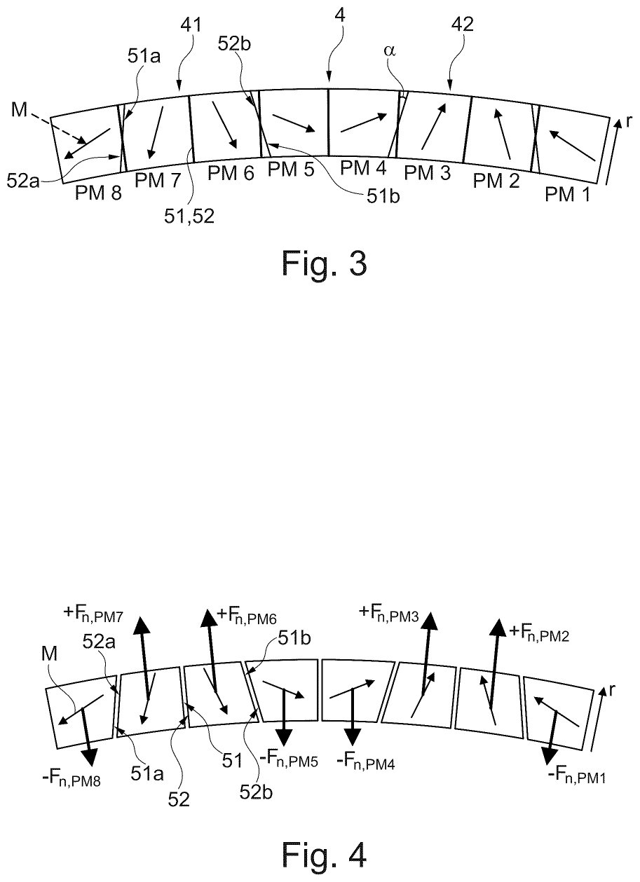

FIG. 3 shows a Halbach array 4 that has been modified relative to the Halbach array in FIG. 1 as regards the orientation of the lateral flanks 51, 52 of the individual segments. In one embodiment, in the case where a tangential segment PM1, PM 4, PM 5, PM 8 and a normal segment PM 2, PM 3, PM 6, PM 7 adjoin one another, the respectively adjoining flanks 51a, 52a, 51b, 52b of the tangential segment and the normal segment have an orientation that deviates from a strictly radial orientation.

Thus, for example, flank 51a of tangential segment PM 8 runs obliquely to the radial direction, which is likewise shown purely for comparison. Likewise, flank 52a of the adjacent normal segment PM 7 runs obliquely to the radial direction. The angle α of the deviation relative to the radial direction is in a range between 1° and 10°, for example. In this case, the width of the tangential segment (e.g., where the width relates to the circumferential direction) increases in the radial direction r, while the width of the normal segment PM 7 decreases in the radial direction r.

In contrast, the mutually adjoining flanks 51, 52 between two tangential segments or between two normal segments (e.g., between normal segments PM 7, PM 8 and between tangential segments PM 5, PM 4) run in the radial direction. Between the normal segment and the tangential segment (e.g., between normal segment PM 6 and tangential segment PM 5), the mutually adjoining flanks 51b, 52b in turn run obliquely to the radial direction. The width of normal segment PM 6 increases in the radial direction, and the width of tangential segment PM 5 increases in the radial direction.

This shaping provides a form fit between the tangential segments and the normal segments. This form fit has the effect that the normal forces directed radially outward onto the normal segments may be partially compensated by the normal forces directed radially inward onto the tangential segments.

This is illustrated by FIG. 4, which also illustrates the respective forces acting on the individual segments PM 1 to PM 8. As shown in the illustration in FIG. 2, the normal forces −Fn acting on the tangential segments PM1, PM 4, PM 5, PM 8 are negative, while the normal forces +Fn acting on the normal segments PM 2, PM 3, PM 6, PM 7 are positive.

Due to the form fit between the tangential segments and the normal segments, the negative force −Fn that acts on the tangential segments is used to bring about a transfer of this force from the tangential segments to the normal segments. As illustrated, the form fit may be provided by slight geometrical adaptations of the magnet segments, where the illustration in FIGS. 3 and 4 is not to scale.

By compensating the radially outwardly directed forces on the normal segments PM 2, PM 3, PM 6, PM 7 using the forces directed radially inward onto the tangential segments PM 1, PM 4, PM 5, PM 8, it is possible in the example under consideration to reduce the resultant normal force to about ⅔ of the original force.

Additional centrifugal forces result, depending on the machine specification and design. In the case of slow-rotating radial flux machines with a high torque density, the centrifugal forces may be smaller than or approximately equal to the magnetic forces acting. Assuming centrifugal and magnetic normal forces of the same size, the arrangement described still results in a reduction of 17% in the load for the magnet positioning and retention device.

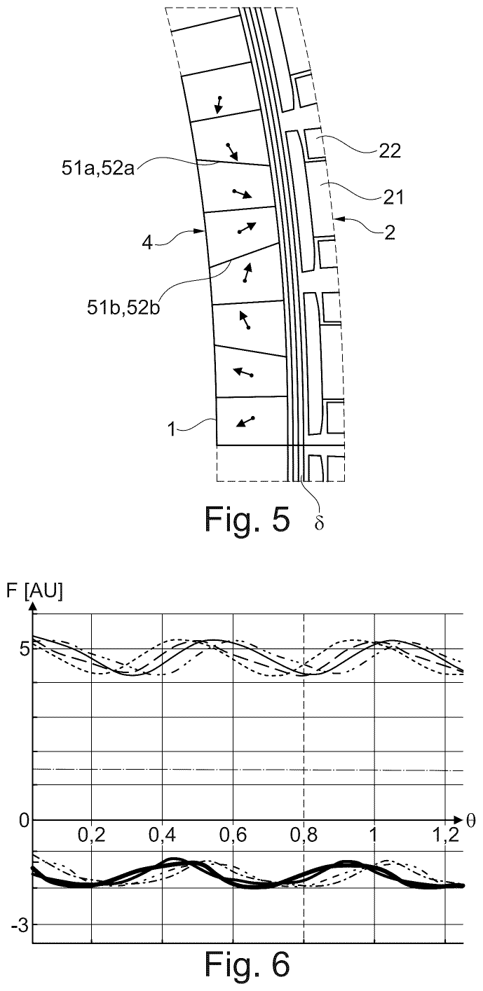

FIG. 5 shows another embodiment of a permanent-magnet synchronous motor having a Halbach array 4 according to the present embodiments. In the embodiment under consideration, the stator 2 is formed by a number of individual teeth 21 with individual-tooth coil windings 22. An air gap & between the rotor 1 and the stator 2 is also illustrated.

Halbach arrays 4 corresponding to FIG. 3 are arranged in the circumferential direction on the outside of the rotor 1, which, like the stator 2, is illustrated only partially in FIG. 5. In this case, mutually adjoining tangential segments and normal segments have flanks 51a, 52a, 51b, 52b that run obliquely to the radial direction and provide a form fit between the tangential segments and the normal segments, which reduces the resulting total forces.

FIG. 6 shows the magnetic normal forces acting on the individual segments against the rotor position θ in the case of a synchronous machine with a concentrated toothed coil winding (q=2/5). The four lower curves, which are associated with a negative normal force (e.g., a radially inwardly directed force) relate to the four tangential segments. The four upper curves, which are associated with a positive normal force, relate to the four normal segments of the Halbach array in FIG. 5. Via the form fit provided by the obliquely running flanks 51a, 52a, 51b, 52b, the forces acting radially outward on the normal segments are partially compensated. In this case, the forces on the retention device are homogenized since the oblique flanks or contact surfaces between the segments provide that equal effective normal forces act on all the segments around the circumference of the rotor. In the case of a bandage, for example, this may further reduce the demands on design and manufacture since no stress peaks (e.g., in the case of very small elastic displacements) due to a nonuniform force distribution are to be expected.

In the case of the embodiment shown in FIG. 6, a negative force on the tangential segments of about ⅓ the intensity of the normal segments is obtained.

In the case of rotors without the influence of a stator, the situation is such that, in this case, the negative forces on the tangential segments have similar absolute values to the positive forces on the normal segments. At the same time, the solution according to the present embodiments may also simplify the mounting of the magnet bars on the rotor. This is a nontrivial task on account of the high magnetic forces, since movement of the already mounted bars is prevented by the form fit, and as a result, it is possible to simplify complex mounting devices and processes.

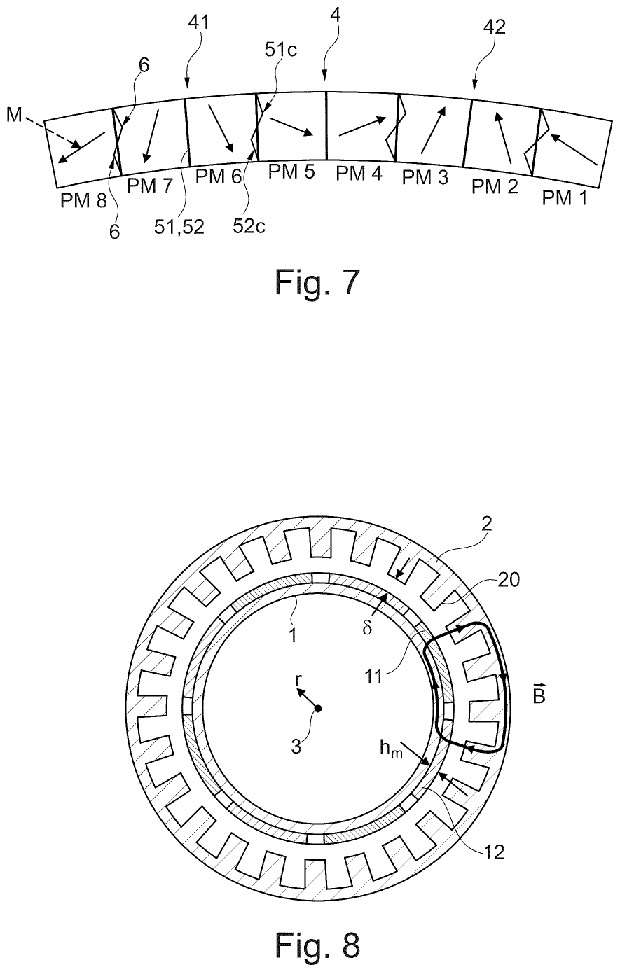

FIG. 7 shows an embodiment in which the form fit between the tangential segments and the normal segments is not provided by flanks that run obliquely to the radial direction and otherwise are planar, but by projections and indentations 6 on the adjacent flanks 51c, 52c. FIG. 7 is purely schematic and illustrative of a flank profile in which the flanks of the mutually adjoining tangential segment and normal segment provide a form fit not by a deviation from a radial orientation but by projections and indentations or convex regions and concave regions; by their very nature, a projection/convex region in one segment entails an indentation/concave region in the adjacent segment.

In other embodiments, the number of segments per magnetic pole is not equal to four and is, for example, just three segments or more than four segments. In the case of an arrangement with three segments (e.g., with one normal segment and two tangential segments), the retaining force of the tangential segments has an even greater influence since in each case two tangential segments partially compensate the radially outwardly directed force on one normal segment. It is also possible to provide that, in the case of a number of more than four tangential segments, there are, in addition, intermediate segments with a magnetization direction between the extremes between the tangential segments and the normal segments.

The invention is not limited to the embodiments described above, and various modifications and improvements may be made without departing from the concepts described here. For example, provision may be made for the synchronous machine described to be configured as an axial flux machine instead of a radial flux machine. In the case of axial flux machines, the centrifugal force acts normally with respect to the magnetic forces, and therefore, the full potential of the load reduction in the axial direction according to the present embodiments may be exploited. In addition, it is also possible, with regard to the centrifugal force, to employ similar shaping in the radial direction to bring about an increase in the static frictional force that counters movement in the axial direction.

Any of the features described may be used separately or in combination with any other features, unless they are mutually exclusive. The disclosure extends to and includes all combinations and sub-combinations of one or more features that are described here. If ranges are defined, these ranges therefore include all the values within these ranges as well as all the partial ranges that lie within a range.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A synchronous machine excited by permanent magnets, the synchronous machine comprising:
a stator; and
a rotor configured to rotate adjacent to the stator about a longitudinal axis,
wherein the rotor has a plurality of surface magnets that are arranged along a circumference of the rotor,
wherein the plurality of surface magnets are configured as Halbach arrays, each of which has tangential segments, in which a magnetization direction is oriented predominantly in the circumferential direction, and normal segments, in which the magnetization direction is oriented predominantly in a radial direction or counter to the radial direction,
wherein, in a field of the stator, the tangential segments are subjected to a radially inwardly directed force and the normal segments are subjected to a radially outwardly directed force,
wherein the tangential segments and the normal segments are shaped such that, by form fitting, the tangential segments partially compensate for forces directed radially outward onto the normal segments by forces directed radially inward onto the tangential segments.

2. The synchronous machine of claim 1, wherein the tangential segments and the normal segments each have two lateral flanks in a cross-sectional view perpendicular to the longitudinal axis of the rotor, wherein a form fit between a respective tangential segment and an adjacent normal segment is provided by virtue of the fact that the flanks of the tangential segment and of the normal segment that adjoin one another in the circumferential direction adjoin one another with a form fit, such that a relative movement in the radial direction is blocked.

3. The synchronous machine of claim 2, wherein the flanks of the tangential segment and of the normal segment that adjoin one another in the circumferential direction have an orientation that deviates from a strictly radial orientation.

4. The synchronous machine of claim 3, wherein the flanks of the tangential segment and of the normal that adjoin one another in the circumferential direction run in a planar manner and, at the same time, obliquely to the radial direction,
wherein a width of the tangential segment in the circumferential direction increases in the radial direction and a width of the normal segment in the circumferential direction decreases in the radial direction.

5. The synchronous machine of claim 4, wherein the flanks run obliquely to the radial direction, such that an angle between the flanks and the radial direction is in a range between 1° and 10°.

6. The synchronous machine of claim 4, wherein the flanks of two tangential segments which that adjoin one another in the circumferential direction and the flanks of two normal segments that adjoin one another in the circumferential direction are oriented in the radial direction.

7. The synchronous machine of claim 3, wherein flanks of the tangential segment and of the normal segment that adjoin one another in the circumferential direction form projections and indentations that provide a form fit.

8. The synchronous machine as claimed in one of the of claim 1, wherein the Halbach arrays have two tangential segments and two normal segments per magnetic pole.

9. The synchronous machine of claim 1, wherein the direction of magnetization changes by a fixed angle between two adjacent segments of the Halbach array.

10. The synchronous machine of claim 1, wherein two magnetic poles are arranged directly adjoining one another in the circumferential direction as a magnetic pole pair.

11. The synchronous machine of claim 1, wherein the surface magnets that are arranged along the circumference of the rotor are fixed on the rotor without an adhesive layer.

12. The synchronous machine of claim 1, wherein the stator of the electrical machine comprises segmented stator coils that are configured as individual tooth coils.

13. The synchronous machine of claim 1, wherein the synchronous machine is configured as a permanent-magnet synchronous motor.

14. The synchronous machine of claim 1, wherein the synchronous machine is configured as a radial flux machine.
